(19) United States
(12) Patent Application Publication
(10) Pub. No.: US 2016/0128473 A1
(43) Pub. Date: May 12, 2016

(54) GEAR MECHANISM USED FOR SLIDE RAIL

(71) Applicant: GUANGDONG TAIMING METAL PRODUCTS CO. LTD, Foshan City (CN)

(72) Inventor: Tai Wai NG, Foshan City (CN)

(73) Assignee: GUANGDONG TAIMING METAL PRODUCTS CO. LTD, Foshan City (CN)

(21) Appl. No.: 14/677,510

(22) Filed: Apr. 2, 2015

(30) Foreign Application Priority Data
Nov. 10, 2014 (CN) 201420667813.1

(51) Int. Cl. A47B 88/10; F16H 19/04; A47B 88/00

(52) U.S. Cl. CPC A47B 88/10; A47B 88/0085; F16H 19/04; A47B 2088/0088; A47B 2210/0075; A47B 2210/0048

(57) ABSTRACT

A gear mechanism used for slide rail, comprising a movable rail, a middle rail and a fixed rail which are mutually nested, an upper gear rack is provided between the movable rail and the middle rail; a lower gear rack is provided between the middle rail and the fixed rail; characterized in that, a gear mechanism is engaged between the upper rack and the lower rack; at least two gears respectively engaged with the upper gear rack and the lower gear rack are provided on the gear mechanism; two gears are closely coordinated and assembled through polygonal column and polygonal hole; when the acting force is greater than a certain value, two gears make relative slipping rotation; when the acting force is less than a certain value; two gears make synchronous rotation. The present invention is provided with a gear mechanism, the gear mechanism also comprises a A gear and a B gear, which are closely coordinated and assembled through polygonal column and polygonal hole respectively; when the acting force is greater than a certain value, the polygonal hole is expanded and two gears make relative slipping rotation; when the acting force is less than a certain value, two gears make synchronous rotation.

### FIELD OF THE INVENTION

The present invention relates to a gear mechanism and in particular relates to a gear mechanism used for slide rail.

### BACKGROUND OF THE PRIOR ART

The drawers available on the market generally use slide rails, and the slide rails with racks engaged with gears have gradually appeared. On Jul. 11, 2012, Chinese patent (documentation number: CN 102551380 A) disclosed a drawer slide rail, comprising an outer slide rail, an inner slide rail and an outer fixing rail, wherein the internal side rail is in slidable connection with the outer slide rail through a first holder, the inner slide rail is in slidable connection with the outer fixing rail through a second holder, characterized in that, duplicate gears are provided on the top or side of the inner slide rail, two gear sets of the duplicate gears are respectively in synchronous transmission connection with the first rack provided on the first holder and the second rack provided on the second holder. In the duplicate gears in this structure, two gears are relatively fixed and thus perform synchronous rotation. However, the movable rail is not synchronous with the middle rail, so that it is easy to cause damage to the gears and racks. Therefore, it is necessary to make further improvement.

### SUMMARY OF THE INVENTION

It is the technical objective of the present utility model to gear mechanism used for slide rail, which is featured by simple and reasonable structure, simple assembly, reliable performance and long service life, so as to overcome the deficiency in the prior art.

A gear mechanism used for slide rail designed according to this objective, comprising a movable rail, a middle rail and a fixed rail which are mutually nested, an upper gear rack is provided between the movable rail and the middle rail; a lower gear rack is provided between the middle rail and the fixed rail; characterized in that, a gear mechanism is engaged between the upper rack and the lower rack; at least two gears respectively engaged with the upper gear rack and the lower gear rack are provided on the gear mechanism; two gears are closely coordinated and assembled through polygonal column and polygonal hole; when the acting force is greater than a certain value, two gears make relative slipping rotation; when the acting force is less than a certain value; two gears make synchronous rotation.

The gear mechanism comprises an A gear (3.1) with polygonal column and a B gear with polygonal hole, and comprises a fixing base (3.3) used to fix two gears.

The polygonal column on the A gear (3.1) is inserted into the polygonal hole of B gear (3.2) to realize close coordination and assembly; in addition, the polygonal column and the polygonal hole are coaxially provided, wherein the polygonal column and the polygonal hole are correspondingly provided.

When the rotational force applied is greater than a certain value, the polygon hole of the B gear naturally expands, so that the A gear and the B gear perform slipping rotation.

The fixing base is center vented, salient points and rotational holes are respectively coaxially provided on left and right sides of inner wall, wherein the rotational holes are communicated upwards with a guiding slot; after assembly, A gear and B gear are installed in the fixing seat and are positioned and rotated through the salient points and the rotational holes

The A gear and the B gear extend upwards/downwards out of the fixing base.

The gear mechanism is inserted into the gear hole provided on the middle rail; hook parts are provided at the front/back ends of the fixing base to clasp the inner wall of the middle rail.

The upper rack is fixed on the movable rail and the low rack makes back and forth movement between the middle rail and the fixed rail.

The present invention is provided with a gear mechanism, wherein the gear mechanism also comprises a A gear and a B gear, which are closely coordinated and assembled through polygonal column and polygonal hole respectively; when the acting force is greater than a certain value, the polygonal hole is expanded and two gears make relative slipping rotation; when the acting force is the while s than a certain value, two gears make synchronous rotation. This change ensures that two gears and upper/lower gears are mutually engaged at correct positions to adapt the needs of slide rail at different stages and effective protect the gears and racks. In addition, this change realizes smoother closing/opening of drawer. The present invention is featured by simple and reasonable structure, simple assembly, reliable performance and long service life.

### DESCRIPTION OF ATTACHED DRAWINGS

FIG. 1 is the exploded view of the slide rail provided with the gear mechanism of the present invention.

FIG. 2 is breakdown structure diagram of the present invention.

FIG. 3 is the schematic diagram of the assembly structure of A gear and B gear in the present invention.

FIG. 4 is the breakdown drawing of the gear mechanism and the middle rail in the present invention.

FIG. 5 is the side sectional view of the assembly of the gear mechanism and the middle rail in the present invention.

FIG. 6 is the front sectional view of the assembly of the gear mechanism and the middle rail in the present invention.

FIG. 7 is the sectional view showing that the gear mechanism of the present invention is engaged with the up/down gear racks.

### DETAILED DESCRIPTION OF PREFERRED EMBODIMENTS

Further detailed description of the present invention is provided with reference to specific embodiments in combination with attached drawings.

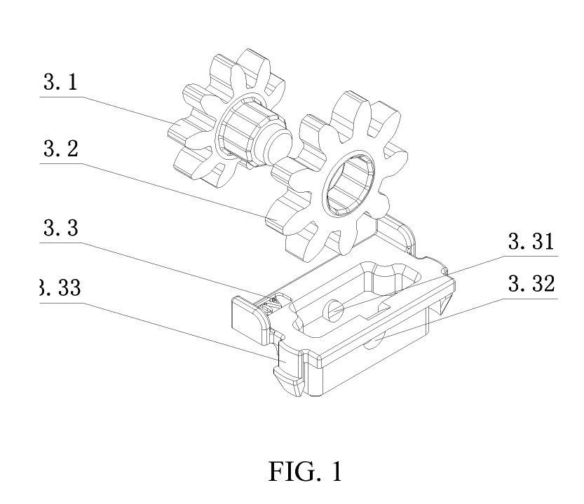

As shown in FIG. 1, This gear mechanism 3 used for slide rail comprises a movable rail A, a middle rail B and a fixed rail C which are mutually nested, an upper gear rack 1 is provided between the movable rail A and the middle rail B; a lower gear rack 2 is provided between the middle rail B and the fixed rail C; characterized in that, a gear mechanism 3 is engaged between the upper rack 1 and the lower rack 2; at least two gears respectively engaged with the upper gear rack 1 and the lower gear rack 2 are provided on the gear mechanism; two gears are closely coordinated and assembled through polygonal column and polygonal hole; when the acting force is greater than a certain value, two gears make relative slipping rotation; when the acting force is less than a certain value; two gears make synchronous rotation. This design can realize the synchronous or mismatched operation between the movable rail and the middle rail, ensure that two gears are coordinated with upper and lower racks and are located on right position. As the result, the slide rail can continue to use three-section synchronization effect and function, and the racks and gears are not liable to damage.

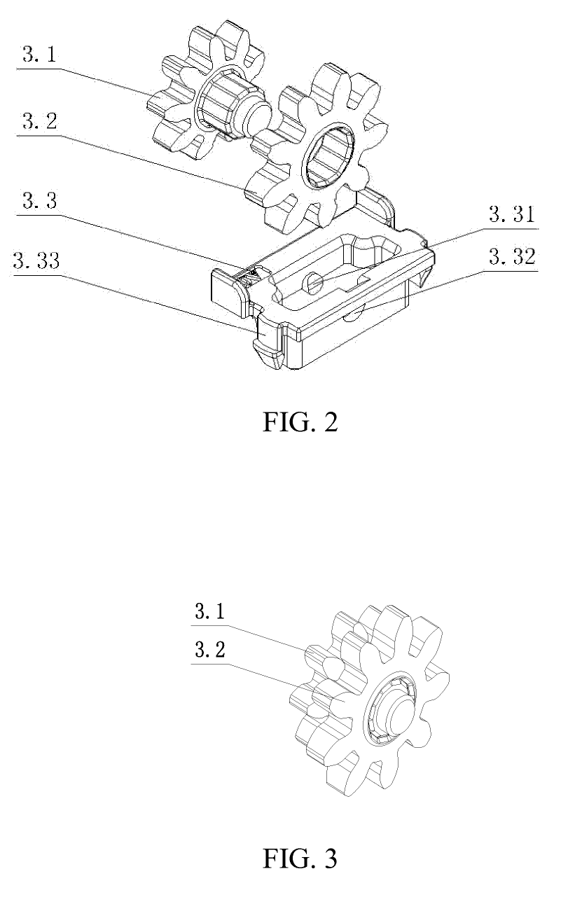

As shown in FIG. 2-3, the gear mechanism 3 comprises a A gear 3.1 with polygonal column and a B gear 3.2 with polygonal hole, and also comprises a fixing base 3.3 used to fix two gears. The polygonal column on the A gear is inserted into the polygonal hole on the B gear 3.2 to realize close coordination and assembly; in addition, the polygonal column and the polygonal hole are coaxially provided, wherein the polygonal column and the polygonal hole are correspondingly provided, namely they have the same number of sides. When the rotational force applied is greater than a certain value, the polygonal hole of the B gear 3.2 naturally expands, so that A gear 3.1 and B gear 3.2 perform slipping rotation.

The fixing base (3.3) is center vented, salient points (3.31) and rotational holes (3.32) are respectively coaxially provided on left and right sides of inner wall, wherein the rotational holes (3.32) are communicated upwards with a guiding slot; after the A gear 3.1 and the B gear 3.2 have been assembled, they are integrally mounted in the fixing base 3.3, then positioned and rotated through the salient points 3.31 and the rotational holes (3.32). A gear 3.1 and B gear 3.2 expand upwards and downwards in the fixing base 3.3.

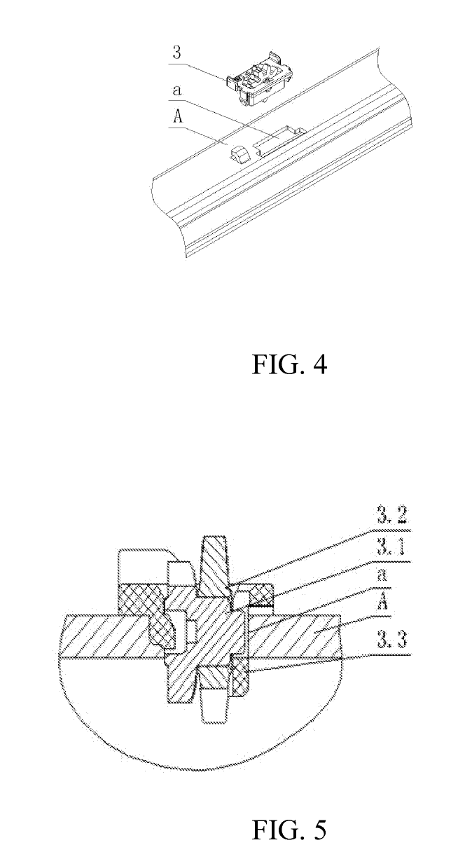

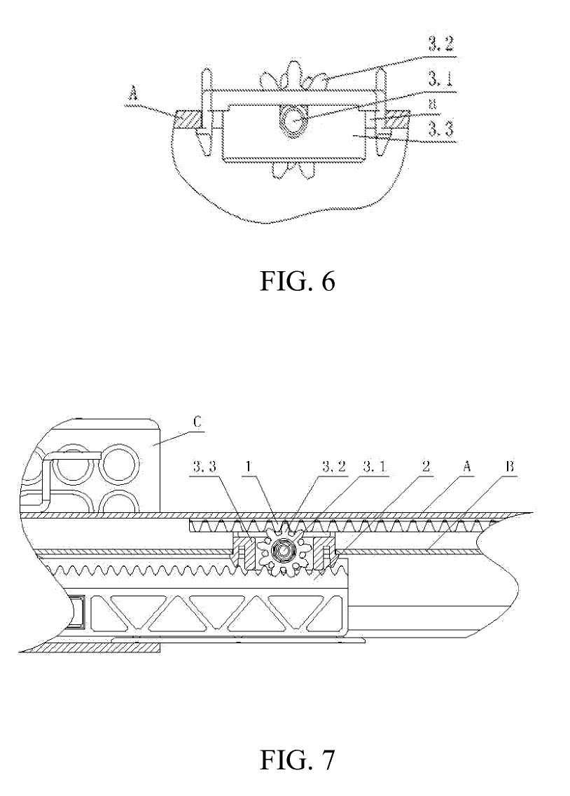

As shown in FIG. 4-6, the gear mechanism is inserted into the gear hole a provided on the middle rail B; hook parts 3.33 are provided at the front/back ends of the fixing base 3.3 to clasp the inner wall of the middle rail B.

As shown in FIG. 7, the upper rack is fixed on the upper wall in the movable rail A, the lower rack 2 makes back and forth movement between the middle rail B and the fixed rail C, the gear mechanism 3 is placed between upper and lower racks, and the A gear 3.1 is engaged with the lower rack 2, B gear 3.2 is engaged with the upper rack 1. Through acting on the movable rail A, the gear mechanism 3 receives the action of rotational force and reach different effects according to the values of rotational force.

The preferred embodiments of the present invention are described above. All the simple modifications or transformations made by those skilled in the art to these embodiments fall within the claims of the present invention.

1. A gear mechanism (3) used for slide rail, comprising a movable rail (A), a middle rail (B) and a fixed rail (C) which are mutually nested, an upper gear rack (1) is provided between the movable rail (A) and the middle rail (B); a lower gear rack (2) is provided between the middle rail (B) and the fixed rail (C); characterized in that, a gear mechanism (3) is engaged between the upper rack (1) and the lower rack (2); at least two gears respectively engaged with the upper gear rack (1) and the lower gear rack (2) are provided on the gear mechanism; two gears are closely coordinated and assembled through polygonal column and polygonal hole; when the acting force is greater than a certain value, two gears make relative slipping rotation; when the acting force is less than a certain value; two gears make synchronous rotation.

2. The gear mechanism (3) used for slide rail of claim 1, characterized in that, the gear mechanism (3) comprise an A gear (3.1) with polygonal column and a B gear (3.2) with polygonal hole, and comprises a fixing base (3.3) used to fix two gears.

3. The gear mechanism (3) used for slide rail of claim 2, characterized in that, the polygonal column on the A gear (3.1) is inserted into the polygonal hole of B gear (3.2) to realize close coordination and assembly; In addition, the polygonal column and the polygonal hole are coaxially provided, wherein the polygonal column and the polygonal hole are correspondingly provided.

4. The gear mechanism (3) used for slide rail of claim 3, characterized in that, when the rotational force applied is greater than a certain value, the polygonal hole of the B gear (3.2) naturally expands, so that the A gear (3.1) and the B gear (3.2) perform sliding rotation.

5. The gear mechanism (3) used for slid rail of claim 2, characterized in that, the fixing base (3.3) is center vented, salient points (3.31) and rotational holes (3.32) are respectively coaxially provided on left and right sides of inner wall, wherein the rotational holes (3.32) are communicated upwards with a guiding slot; after assembly, A gear (3.1) and B gear (3.2) are installed in the fixing seat (3.30) and are positioned and rotated through the salient points (3.31) and the rotational holes (3.32).

6. The gear mechanism (3) used for slid rail of claim 5, characterized in that, the A gear (3.1) and B gear (3.2) extend upwards/downwards out of the fixing base (3.3).

7. The gear mechanism (3.3) used for slide rail as disclosed in any of claims 1-6, characterized in that, the gear mechanism (3) is inserted into the gear hole (a) provided on the middle rail (B); hook parts (3.33) provided at the front and rear ends of the fixing base (3.3) are used to clasp the inner wall of the middle rail (B).

8. The gear mechanism (3) used for slide rail of claim 1, characterized in that, the upper gear rack (1) is fixed on the movable rail (A), and the lower gear rack (2) is designed to make back and forth movement between the middle rail (B) and the fixed rail (C).
